(19) United States
(12) Patent Application Publication
(10) Pub. No.: US 2023/0347706 A1
(43) Pub. Date: Nov. 2, 2023

(54) Air Conditioning Unit

(71) Applicant: Dometic Sweden AB, Solna (SE)

(72) Inventors: Samuele Meda, Chichester (GB); Anton Lundqvist, Älvsjö (SE)

(21) Appl. No.: 17/998,620

(22) PCT Filed: May 4, 2021
(86) PCT No.: PCT/EP2021/061678

§ 371 Date: Nov. 11, 2022

(30) Foreign Application Priority Data
May 15, 2020 (DE) 10 2020 206 182.3

(51) Int. Cl. B60H 1/00

(52) U.S. Cl. CPC B60H 1/00364

(57) ABSTRACT

The present invention relates to an air conditioning unit configured to be mounted externally on a vehicle and which comprises a housing that spatially separates an interior of the air conditioning unit from the environment, the air conditioning unit is configured such that a connection hub is removably mountable to the outside of the housing in order to route one or more cables from the environment to the interior of the air conditioning unit via the connection hub. The present invention further relates to a construction kit for the air conditioning unit, the construction kit including the connection hub.

This 35 U.S.C. § 371 National Stage Patent application claims priority to PCT Patent Application No. PCT/EP2021/061678, filed May 4, 2021, which claims priority to and benefit of DE Patent Application Serial Number 102020206182.3, filed May 15, 2020, all of which is incorporated by reference herein.

The present embodiments relate to an air conditioning unit in particular to an air conditioning unit as used on the rooftop of a recreational vehicle, and to a construction kit for such an air conditioning unit.

Recreational vehicles are often equipped or retrofitted with several components for which access from the outside to the inside of the recreational vehicle is required. In case the user wants to install, for example solar panels, lights, or other equipment on the roof of the recreational vehicle, it is necessary to drill holes into the roof and to route the cables from outside the vehicle to the inside. This can lead to water leaks and should for this reason generally be done by an expert, which involves additional costs.

The present embodiments aim to provide a solution for the above problem, which is based on the general concept that the user can use the air conditioning unit that is mounted on the rooftop of the recreational vehicle as kind of a tunnel that already connects the outside with the inside.

Accordingly, the present embodiments provide as a first aspect an air conditioning unit that is configured to be mounted on a vehicle, in particular to the external of the vehicle and which comprises a housing that spatially separates an interior of the air conditioning unit from the environment.

According to the present embodiments, the air conditioning unit is configured such that a connection hub is removably mountable to the outside of the housing in order to route one or more cables from the environment to the interior of the air conditioning unit via the connection hub. As such, cables that are intended to reach from the outside to the inside of the air conditioning unit can be secured and properly routed, when the connection hub is mounted.

The air conditioning unit is configured such that the cables can be further routed inside the vehicle. As such, cables that are intended to reach from the outside to the inside of the vehicle via the air conditioning unit can be secured and properly routed, when the connection hub is mounted.

In accordance with some embodiments, the air conditioning unit has a connection area for providing a sealed connection to the vehicle. In the connection area, the housing has a first opening and a second opening. The air conditioning unit further comprises a first air circuit that extends inside the air conditioning unit between the first opening and the second opening. During operation of the air conditioning unit, air from the interior of the vehicle is drawn through the first opening into the first air circuit and is fed through the second opening back into the interior of the vehicle. In this embodiment, the air conditioning unit is configured such that the cables can be routed along at least a part of the first air circuit and inside the vehicle via the first opening or the second opening. Hence no additional opening/openings has/have to be provided in the housing of the air conditioning unit for letting the cables enter the interior of the vehicle.

In accordance with some embodiments, the air conditioning unit further comprises a casing forming an air duct. The air duct serves as at least a portion of the first air circuit inside the casing. The casing is configured to provide access for the cables inside the portion of the first air circuit formed by the casing.

The casing has a cutout region for providing the access. The cutout region is designed to removably receive a cover insert to cover the cutout region. The cover insert may have one or more through holes for routing the cables as intended.

The casing may be configured so that a cable guiding part for further guiding the cables inside the first air circuit is removably mountable to the casing at a region inside the air duct formed by the casing. This further protects the cables from damage from rotating fans in the respective air circuit.

In accordance with some embodiments, the casing is composed of at least two molded parts. The molded parts are connected to each other and the cutout region is located at a connection area between two of the molded parts. As such, access to the cutout region can be provided simply by removing one of the two molded parts that are connected to each other and where the cutout region is located at the respective connection area.

The material of the molded parts is not particularly limited. For example, the at least two molded parts are formed of a plastic foam material. This results in a relatively low weight. Furthermore, plastic foam materials like expanded polystyrene, expanded polypropylene and similar materials are sufficiently stabile for this purpose. Moreover, plastic foam materials like expanded polystyrene, expanded polypropylene and similar materials have temperature isolating properties, which is advantageous, since the temperatures in the first and second air circuit are typically significantly different from each other. The plastic foam material includes expanded polypropylene in some examples. With expanded polypropylene, a high stiffness can be reached and components made of expanded polypropylene are of high durability.

In accordance with some embodiments, the air conditioning unit includes the connection hub being removably mounted to the outside of the housing. This represents the air conditioning unit of the present embodiments that are actually equipped with the connection hub.

In accordance with some embodiments, the connection hub comprises a plurality of cable ducts. The cable ducts enable a routing of the cables from the environment through the connection hub and into the interior of the air conditioning unit. As such, the cables can be properly guided to the surface of the housing. The way the cables enter the housing of the air conditioning unit is not particularly limited. The air conditioning unit has air vents at a side and the connection hub is mounted to the housing in a region that at least partially overlaps with the air vents. The air vents may have the form of slots, more preferably vertical slots. As such, the cables can enter the air conditioning unit and pass the housing via the air vents or, respectively, the slots. In such embodiments, it may be that the cable ducts of the connection hub have a distance to each other that is equal to the distance of the respective air vents or, respectively, the slots through which the cables reach through to the inside.

In accordance with some embodiments, the air conditioning unit further includes the cover insert, wherein the cover insert is arranged in the cutout region of the casing. The cover insert has one or more through holes for routing the cables as intended. The cover insert is formed of a plastic foam material, for example including expanded polypropylene. The cover insert comprises a rubber gasket at the one or more through holes. As such, the cables can be firmly and securely guided inside the interior air circuit (first air circuit) of the air conditioning unit in a sealed manner to avoid water ingress.

In accordance with some embodiments, the air conditioning unit includes the cable guiding part being removably mounted to the casing at a region inside the air duct formed by the casing and in the vicinity of the cover insert. As such, the cables entering the first air circuit via the through holes of the cover insert are directly guided further by the cable guiding part, thereby minimizing the risk of a loose cable that is forced by the airflow to somewhere where it is not supposed to be or the risk of damages of the cable. The cable guiding part may be formed of a plastic foam material, preferably including expanded polypropylene.

According to a second aspect, the present embodiments provide a construction kit including a connection hub for routing one or more cables. The connection hub is configured to be removably mountable to the outside of the housing of the air conditioning unit, in order to route one or more cables from the environment to the interior of the air conditioning unit via the connection hub. The connection hub of the construction kit corresponds to the connection hub described above in the context of the first aspect of the embodiments. Therefore, some properties and constructional features of the above connection hub also relate to and can be combined with the connection hub of the construction kit.

The present embodiments will be further explained in the following by use of the exemplary embodiments illustrated in the accompanying drawings, in which

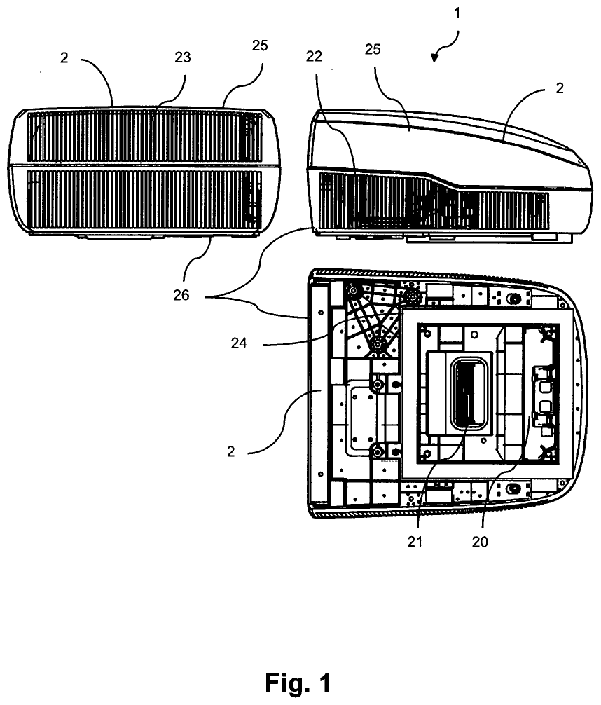

FIG. 1 shows an embodiment of the air conditioning unit from several different perspectives;

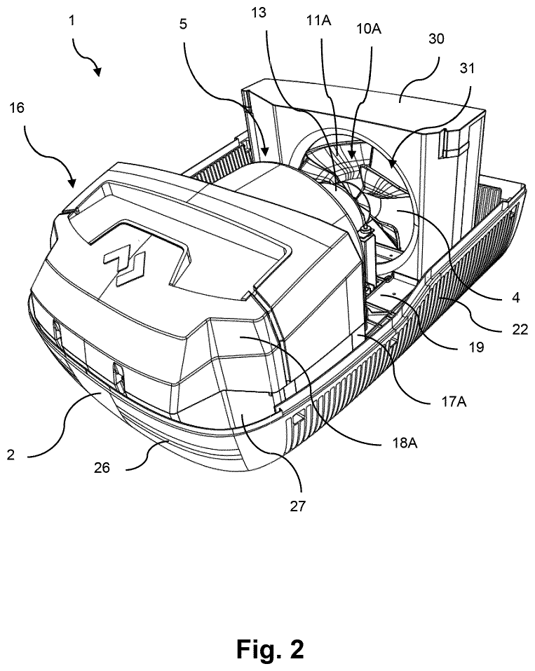

FIG. 2 shows a perspective view of a first embodiment of the air conditioning unit with open housing;

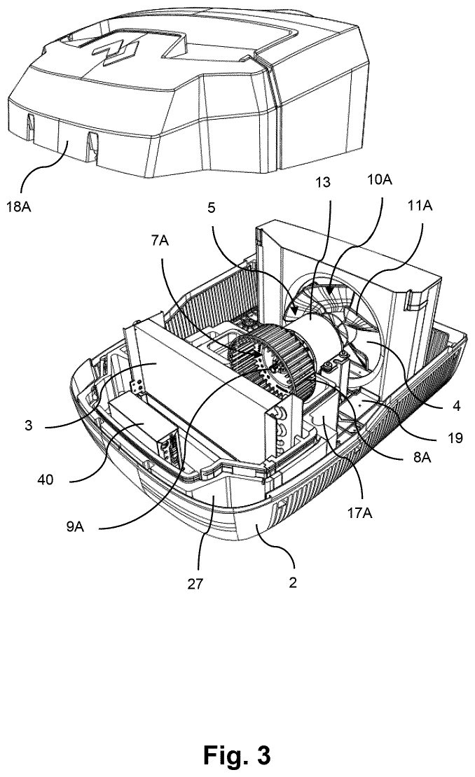

FIG. 3 shows an exploded view of the air conditioning unit shown in FIG. 2;

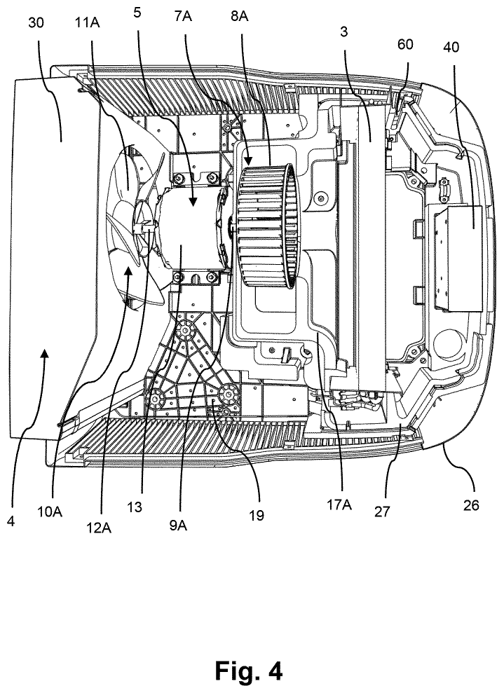

FIG. 4 shows a top view inside the air conditioning unit shown in FIGS. 2 and 3;

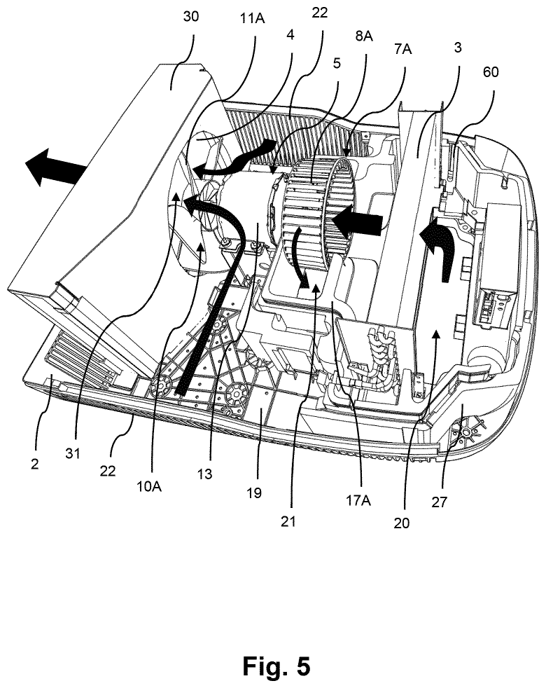

FIG. 5 shows a perspective view of the air conditioning unit shown in FIGS. 2 to 4 illustrating the working principle;

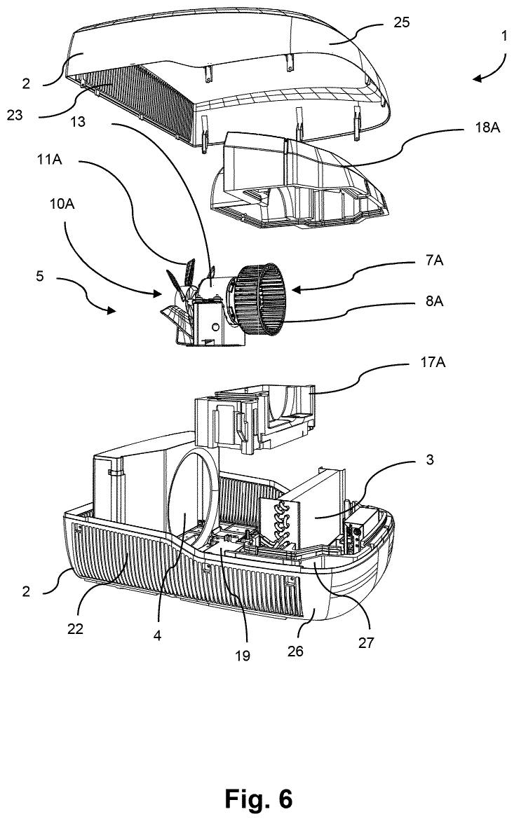

FIG. 6 shows an exploded view of the air conditioning unit shown in FIGS. 2 to 5;

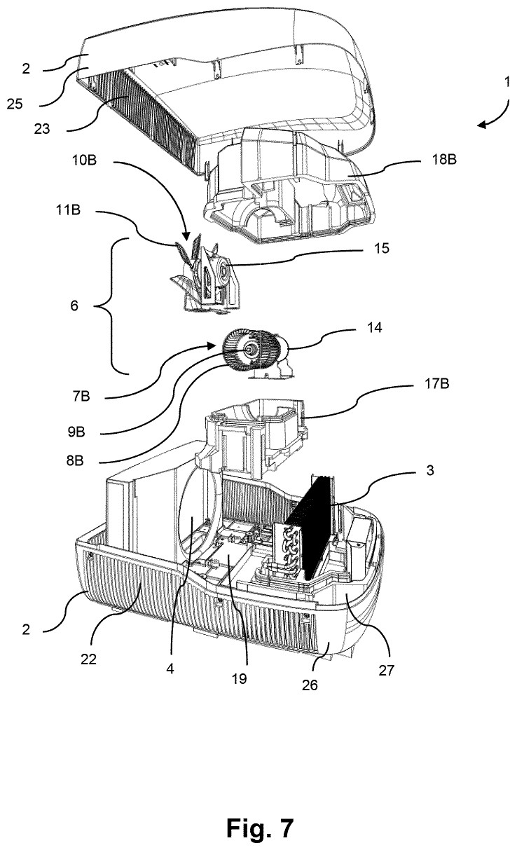

FIG. 7 shows an exploded view of the air conditioning according to a second embodiment;

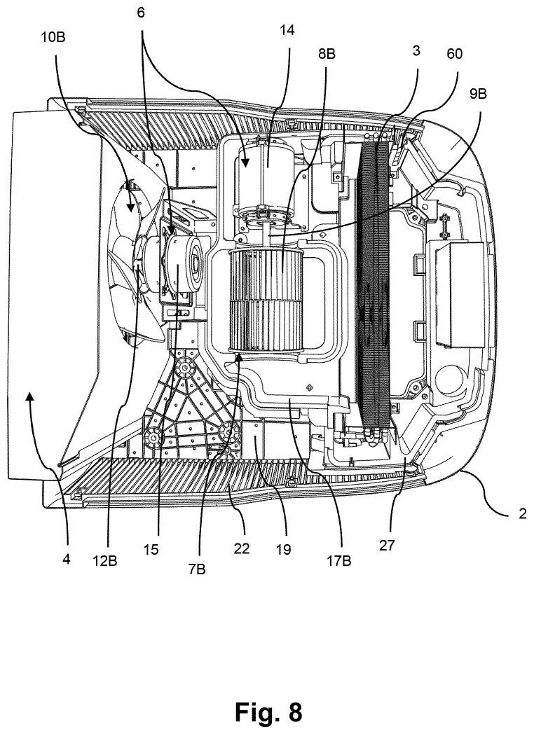

FIG. 8 shows a top view inside the air conditioning unit shown in FIG. 7;

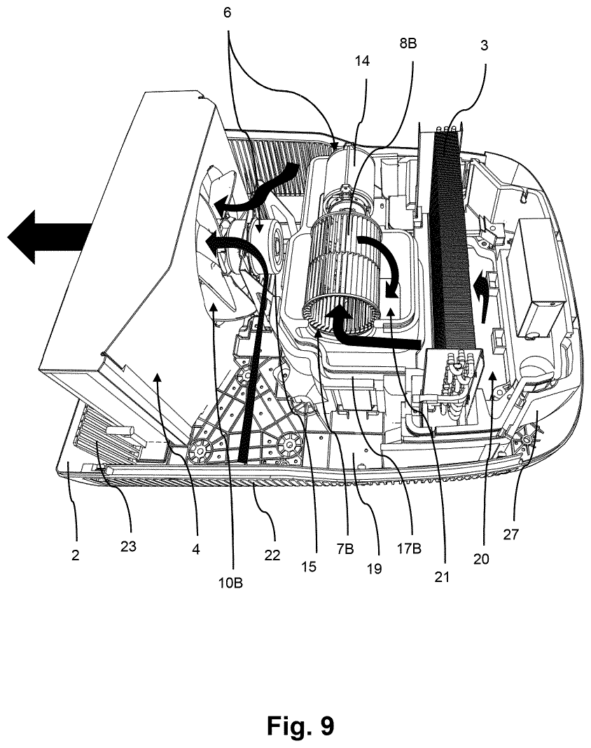

FIG. 9 shows a perspective view of the air conditioning unit shown in FIGS. 7 and 8 illustrating the working principle;

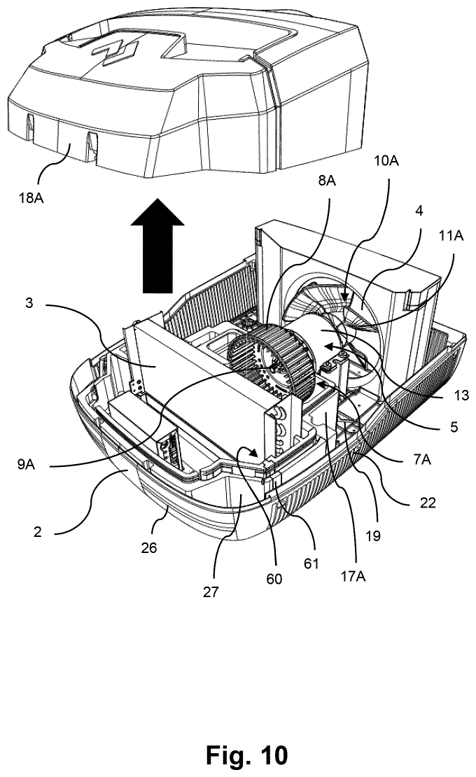

FIG. 10 illustrates a step of removing a component of the air conditioning unit according to the first embodiment;

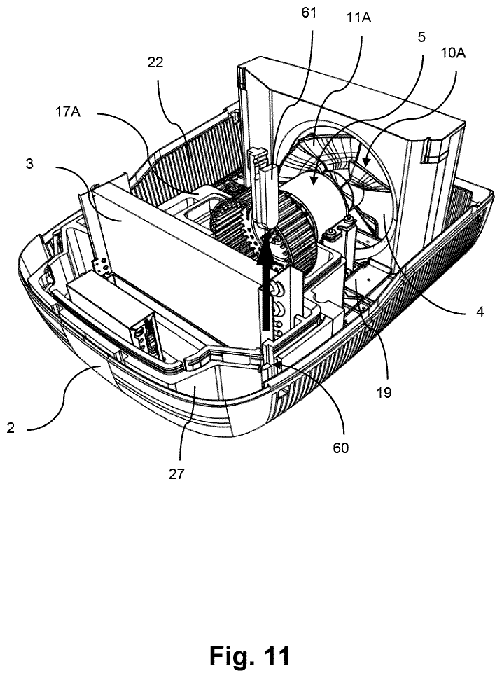

FIG. 11 illustrates a step of removing a further component of the air conditioning unit subsequently to the step shown in FIG. 10;

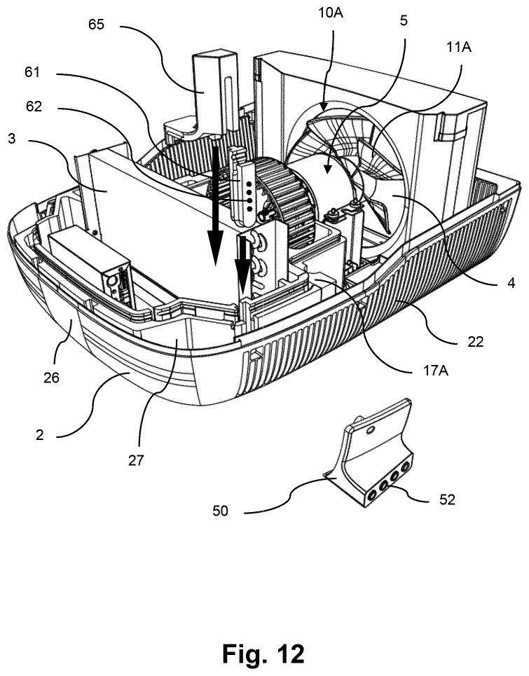

FIG. 12 illustrates a step of adding components of the air conditioning unit subsequently to the step shown in FIG. 11;

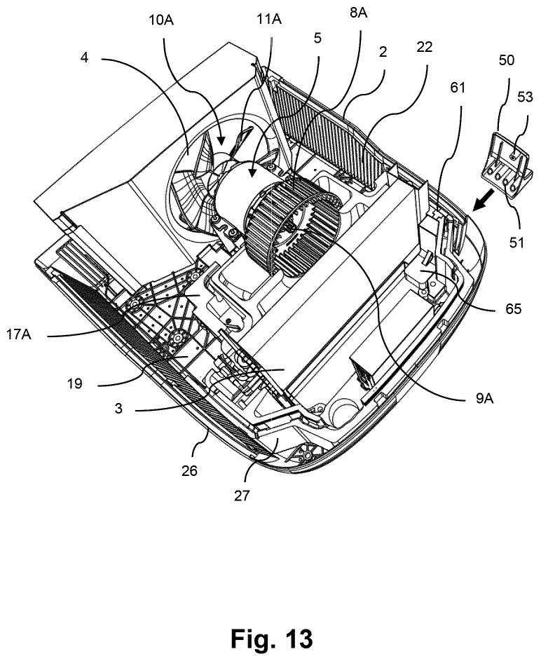

FIG. 13 illustrates a step of adding a further component of the air conditioning unit subsequently to the step shown in FIG. 12;

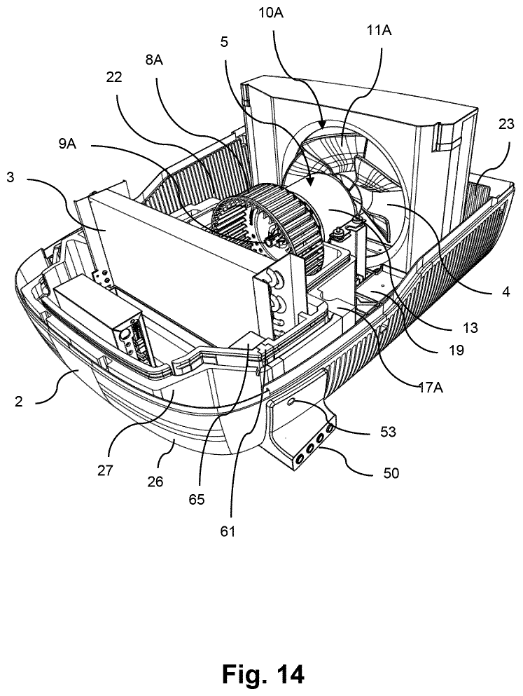

FIG. 14 shows a perspective view of the air conditioning unit as assembled in FIG. 13;

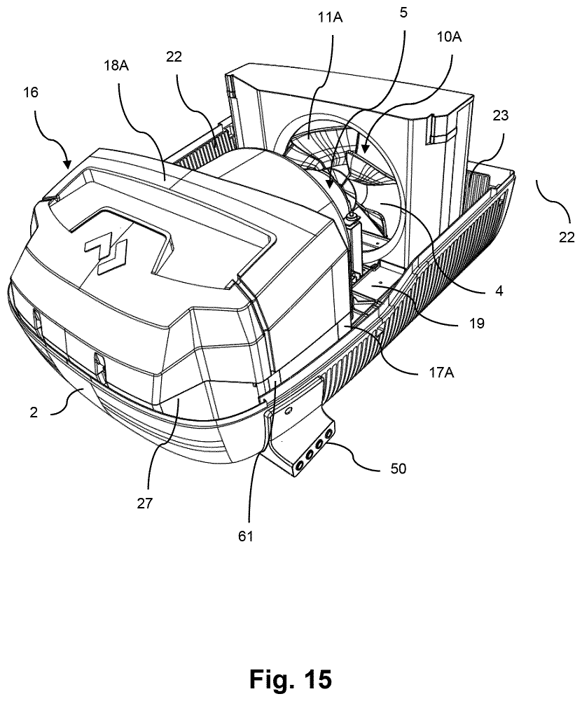

FIG. 15 shows a perspective view of the air conditioning unit of FIG. 14 with the molded cover part;

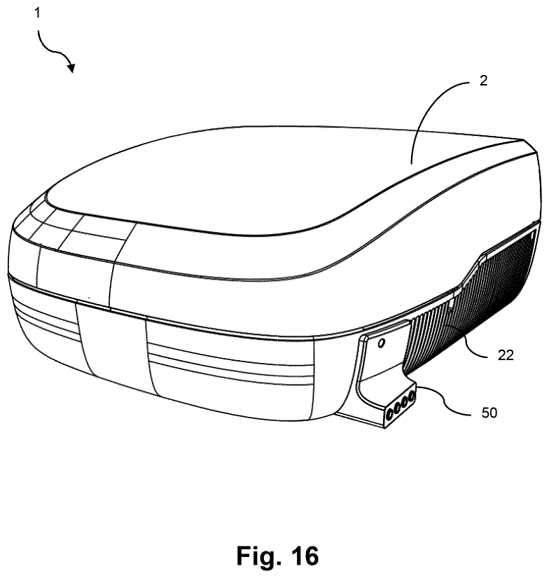

FIG. 16 shows a perspective view of the air conditioning unit of FIG. 15 with closed housing;

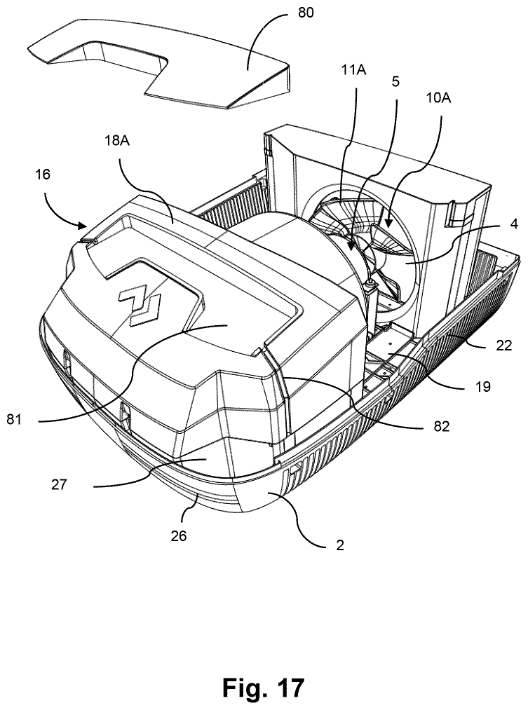

FIG. 17 shows an exploded view of the air conditioning unit shown in FIG. 2 with an antenna;

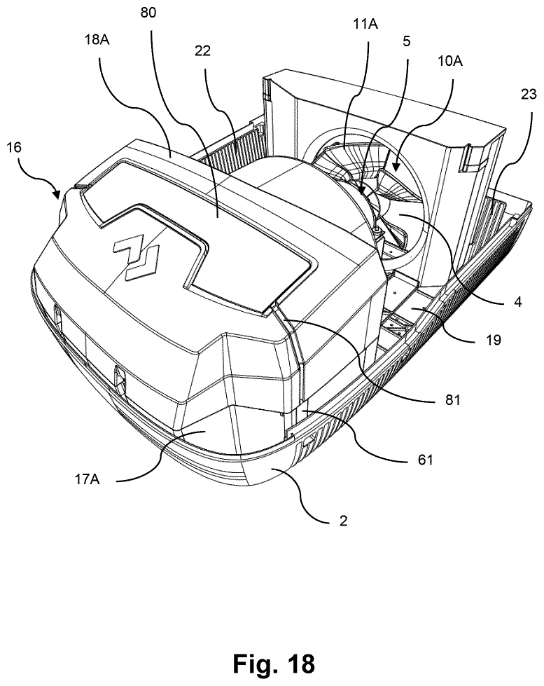

FIG. 18 shows the air conditioning unit of FIG. 17 with the antenna in place;

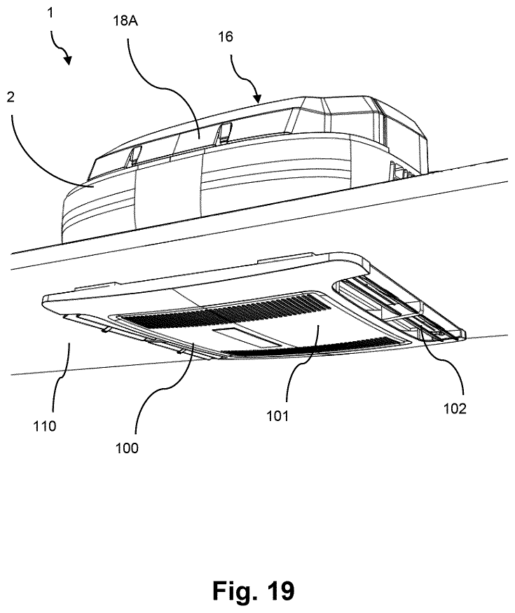

FIG. 19 shows a perspective view of an embodiment of the air conditioning system mounted on a roof of a vehicle; and

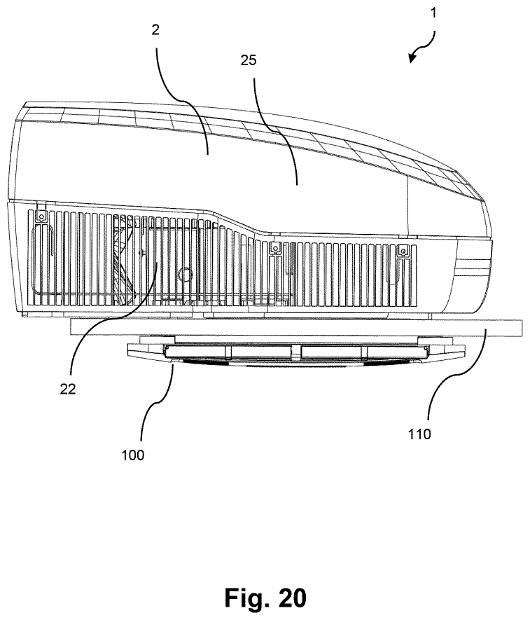

FIG. 20 a side view of the mounted air conditioning system shown in FIG. 19.

Identical components of the first and second embodiment of the air conditioning unit are assigned identical reference numbers in the drawings and in the following detailed description. The reference numbers of corresponding components of the first and second embodiment of the air conditioning unit that, however, differ from each other in the specific design are additionally marked with the letters A and B, wherein “A” refers to the first embodiment and “B” refers to the second embodiment of the air conditioning unit.

In the framework of the present embodiments, terms relating to an orientation or direction like, for example, front, rear, side, bottom, top and the like refer to the air conditioning unit or system when mounted on the rooftop of a vehicle and with respect to the travelling direction of the vehicle, unless explicitly mentioned otherwise.

FIG. 1 shows the outer appearance of the air conditioning unit 1 from behind (upper left drawing), from the side (upper right drawing) and from below (lower right drawing). Practically, the entire air conditioning unit 1 is covered by the housing 2. The housing 2 has two parts, wherein the upper part being the lid part 25 that can be removed for opening the air conditioning unit 1, also in a mounted state, for example on the roof 110 of the vehicle, as shown in FIG. 19. The lower part of the housing 2 is the base part 26 in which most of the interior components of the air conditioning unit 1 are arranged.

As it is typical for such air conditioning units, two separated air circuits are formed inside the air conditioning unit 1, an interior vehicle air circuit and an ambient air circuit. In the framework of the present invention, the air circuit of the vehicle interior air is designated as the first air circuit and the air circuit of the ambient air is designated as the second air circuit.

For the first air circuit, the air conditioning unit 1 has on its underside a first opening 20 and a second opening 21. The first opening 20 serves as the inlet of the vehicle interior air. The second opening 21 serves as the outlet of conditioned air that is to be fed back into the interior of the vehicle. Thereby, the connection area 24 provides for a sealed connection between the air conditioning unit 1 and the roof 110. For a proper distribution of conditioned air inside the vehicle the first opening 20 and the second opening 21 are coupled with the air distribution unit 100 which is mounted inside the vehicle, as it will be explained in further detail below with reference to FIGS. 19 and 20.

For the second air circuit, the air conditioning unit 1 has on its sides first air vents 22. The first air vents 22 serve as the inlet for ambient air. Second air vents 23 are located on the back side of the air conditioning unit 1. The second air vents 23 serve as the ambient air outlet.

FIG. 2 shows the first embodiment of the air conditioning unit 1 with the lid part 25 of the housing 2 being removed. The first embodiment of the air conditioning unit 1 includes the specific fan arrangement 5 (first fan arrangement). The first fan arrangement 5 is essentially composed of a common motor 13 that drives two fans, one for each of the first air circuit and the second air circuit.

On the base portion 19 inside the air conditioning unit 1, a casing 16 is arranged. The casing 16 forms an air duct inside serving as a portion of the first air circuit. The casing 16 is formed of expanded polypropylene which has good temperature isolating properties and is a very light-weight material. The casing 16 is composed of three molded parts, namely the first molded part 17A, the second molded part 18A and the third molded part 27. The casing 16 is arranged at the front side of the air conditioning unit 1. The second molded part 18A and the first molded part 17A are held together and in place by the housing 2. In particular, the second molded part 18A is held in place by the lid part 25 of the housing 2.

The first molded part 17A and the second molded part 18A are connected to the third molded part 27. The third molded part 27 is installed at the base portion 19 in the region of the evaporator 3. The casing 16 thereby forms an air duct representing the entire first air circuit inside the air conditioning unit 1. Since the evaporator 3 is not intended to be replaceable as it is the case with the fan arrangements 5 and 6, the third molded part 27 remains the same in both the first and the second embodiment of the air conditioning unit 1. Each of the first molded part 17A, the second molded part 18A and the third molded part 27 is formed of expanded polypropylene.

At the rear side of the air conditioning unit 1 a condenser 4 is arranged. The condenser 4 is enclosed by the condenser housing 30. The condenser housing 30 is also made of expanded polypropylene and is open at its front and rear side allowing air to pass through. The front opening 31 is round in shape in order to match with the impeller 11A (second impeller of the first fan arrangement). The condenser is cooled by ambient air which is sucked through the first air vents 22 and guided to the condenser 4 by the second fan 10A of the first fan arrangement 5. The second fan 10A is driven by the common motor 13. Hot air is discharged through the second air vents 23 and guided back into the environment.

In FIG. 3. the second molded part 18A is lifted upwards. Thereby the interior of the casing 16 is visible. As mentioned above, the casing 16 forms the first air circuit and, thus, contains the evaporator 3 of the air conditioning unit 1 that cools down the vehicle interior air. The air flow in the first air circuit is generated by the first fan 7A of the first fan arrangement 5. The first fan 7A includes the first impeller 8A and the first shaft 9A about which the first impeller 8A rotates by the driving force of the common motor 13. The first impeller 8A of the first fan arrangement 5 is enclosed by the casing 16. In particular the first impeller 8A is enclosed by the first and second molded parts 17A and 18A of the casing 16.

The first fan 7A of the first fan arrangement 5 is a centrifugal fan that discharges air in a radial direction with respect to the axis of rotation of the fan. The second fan 10A of the first fan arrangement 5 is an axial fan. As mentioned above, both the first fan 7A and the second fan 10A of the first fan arrangement 5 are driven together by the common motor 13. The common motor 13, the first fan 7A and the second fan 10A together form the first fan arrangement 5 with which the air conditioning unit 1 is equipped.

FIG. 4 represents a kind of a floor plan of the base part 26 of the housing 2. Here, it can be identified that the first shaft 9A and the second shaft 12A of the first fan arrangement 5 are arranged colinear with respect to each other. The common motor 13 is fixed to the base portion 19 of the base part 26. The base part 26 is equipped with several threaded bores for fixing the multiple components. For a better overview, a number said components that are not in close context with the present embodiments are not shown in the figures, which is the reason why some fixing means on the base portion are unoccupied and visible in the figures.

Further in FIG. 4, the upper edge of the first molded part 17A of the casing 16 can be identified. The first shaft 9A reaches through the connection area between the first molded part 17A and the second molded part 18A of the casing 16. Thus, the first impeller 8A is completely enclosed within the first air circuit. Also integrated into the first air circuit is an electronic control unit 40. The electronic control unit 40 is particularly located upstream the evaporator 3 near the inlet for the interior vehicle air. This ensures a constant and moderate temperature for the control unit 40.

In FIG. 5 the air flow in the first and second air circuits is illustrated by arrows. With regard to the interior air of the vehicle, the air enters the first air circuit through the first opening 20 and flows around and passes by the evaporator 3. Now, the coolant in the evaporator 3 is heated up and evaporates, thereby extracting thermal energy from the air, which consequently cools down. The first fan 7A then takes in the cooled air axially and discharges the air in the radial direction through the blades of the first impeller 8A. In order to avoid a mixing of the discharge air and the intake air again, the air duct formed by the first molded part 17A and the second molded part 18A fits with the circumferential edge of the first impeller 8A at the air intake side, meaning the distal end of the first impeller 8A with respect to the common motor 13. After being radially discharged by the first fan 7A, the air is guided downwards and is fed through the second opening 21 back into the interior of the vehicle.

With regard to the ambient air, the ambient air enters the second air circuit through the first air vents 22 on both lateral sides of the air conditioning unit 1. The ambient air is guided to the second fan 10A of the first fan arrangement 5. The second impeller 11A fits into the front opening 31 of the condenser housing 30 in order to effectively and efficiently force the ambient air to flow around the condenser 4. In the condenser 4, the vaporous coolant is cooled down by the ambient air and condenses, and the air in turn is heated up. The heated air is finally discharged back into the environment via the second air vents 23 located being at the rear side of the air conditioning unit 1.

In FIG. 6 the assembly of the first fan arrangement 5 with the first molded part 17A and the second molded part 18A of the casing 16 is illustrated. As such, when installing the first fan arrangement 5 into the air conditioning unit 1, the first molded part 17A is mounted to the base portion 19 of the housing 2 inside the air conditioning unit 1. Next, the first fan arrangement 5 is mounted to the base portion 19. Thereby, the first impeller 8A of the first fan 7A fits into a cavity of the first molded part 17A. Finally, the second molded part 18A is placed from above onto the first molded part 17A and the third molded part 27. The second molded part 18A, thus, is a cover that finally establishes the first air circuit as the casing 16 is formed. The second molded part 18A has a cavity enclosing the upper part of the first impeller 8A of the first fan 7A of the first fan arrangement 5.

When the mounting is completed, the lid part 25 of the housing 2 is placed onto the base part 26 of the housing 2, thereby closing the air conditioning unit 1. The lid part 25 secures the second molded part 18A from being moved upwards and, thus, keeps the casing 16 together.

FIG. 6 further illustrates the exchangeability of the fan arrangement that is installed in the air conditioning unit 1. The first fan arrangement 5 having a common motor 13 for both the first and the second fan 7A and 10A may not have enough power, may have not enough performance or may be too loud in the opinion of the user. The user, therefore, has the possibility, instead of referring to and achieving an entirely new air conditioning unit, to dismount the first fan arrangement 5 and to kind of upgrade the air conditioning unit 1 by installing another fan arrangement having different characteristics and performance which fulfill the user's needs. An example of such an upgrade fan arrangement having different characteristics and performance is the second fan arrangement 6, the assembly of which is illustrated in FIG. 7.

The second fan arrangement 6 includes the first fan 7B and the second fan 10B. In the second fan arrangement each of the first fan 7B and the second fan 10B is equipped with a separate motor, while the first motor 14 drives the first fan 7B and the second motor 15 drives the second fan 10B. The first and the second motors 14 and 15 are controlled separately and can, thus, be driven more effectively and efficiently according to the circumstances and user's needs.

In analogy to the first fan arrangement 5, the first fan 7B of the second fan arrangement 6 is designated to generate an air flow in the first air circuit in order to enhance an exchange of thermal energy between the air flowing in the first air circuit and the evaporator 3. Therefore, the isolating casing 16 encloses the first impeller 8B of the first fan 7B of the second fan arrangement 6.

Assembling the second fan arrangement 6 also works analogously to the first fan arrangement 5. After the removable components of the first fan arrangement 5 and its casing 16, as illustrated in FIG. 6, have been removed, the first and second molded parts 17B and 18B and the second fan arrangement 6 are installed by mounting the first molded part 17B to the base portion 19 of the base part 26 of the housing 2 inside the air conditioning unit 1. Next, the second fan 10B is mounted together with the second motor 15 of the second fan arrangement 6 to the base portion 19. The first fan 7B of the second fan arrangement 6 is mounted together with the first motor 14 as a whole in a cavity of the first molded part 17B. Finally, the second molded part 18B is placed from above onto the first molded part 17B and the third molded part 27. The second molded part 18B, thus, acts as a cover that finally establishes the first air circuit as the casing 16 is formed. The second molded part 18B has a cavity enclosing the upper part of the first impeller 8B of the first fan 7B and for the first motor 14 of the second fan arrangement 6.

When the mounting is completed, the lid part 25 of the housing 2 is placed onto the base part 26 of the housing 2, thereby closing the air conditioning unit 1. The lid part 25 thereby secures the second molded part 18B from being moved upwards and, thus, keeps the casing 16 together.

In analogy to FIG. 4 a perspective floor plan of the base part 26 of the housing 2 according to the second embodiment of the air conditioning unit 1 is illustrated in FIG. 8. In the second embodiment of the air conditioning unit 1 the second fan arrangement 6 is installed. As mentioned above, the second fan arrangement 6 is composed of two separate components, one of which includes the first fan 7B and the first motor 14, which component is entirely enclosed by the casing 16. The motor 14 is mounted via a mounting plate on an area of the first molded part 17B inside the first air circuit. The first fan 7B or, respectively, the first impeller 8B of the first fan 7B is a centrifugal fan that sucks air in an axial direction from both sides, the distal end side and the proximal end side of the first impeller 8B with respect to the motor. At these locations, the first and second molded parts 17B and 18B are formed in that the air that is discharged from the first impeller 8B in the radial direction does not mix again with the air previously sucked in.

The second fan 10B of the second fan arrangement 6 is quite similar to the second fan 10A of the first fan arrangement 5 except that it equipped with a separate motor, namely the second motor 15. The second fan 10B and the second motor 15 form the other one of the two separate components of the second fan arrangement 6. The second motor 15 is fixed to a mounting bracket that is mounted on the base portion 19.

FIG. 9 illustrates by arrows the air flowing through the first and second air circuits when the air conditioning unit 1 is running With regard to the ambient air, the air flow is equivalent to that of the first embodiment. The air enters the second air circuit through the first air vents 22 on both lateral sides of the air conditioning unit 1. The air is guided to the second fan 10B of the second fan arrangement 6. The second impeller 11B fits into the front opening 31 of the condenser housing 30 in order to effectively and efficiently force the air to flow around the condenser 4. The heated air that is heated up by the condenser is finally discharged back into the environment via the second air vents 23 at the rear side of the air conditioning unit 1.

With regard to the interior air of the vehicle, the air enters the first air circuit through the first opening 20 and flows around and passes by the evaporator 3. Thereby thermal energy is extracted from the air, and consequently the air cools down. The first fan 7B then takes in the cooled air axially from both sides, as explained above. The air is discharged in the radial direction through the blades of the first impeller 8B. In order to avoid a mixing of the discharge air and the intake air again, the air duct formed by the first molded part 17B and the second molded part 18B fits with the circumferential edge of the first impeller 8B at both air intake sides of the first impeller 8B, meaning the distal end and the proximal end of the first impeller 8A with respect to the first motor 14. After being discharged in the radial direction by the first fan 7B, the air is guided downwards and is fed through the second opening 21 back into the vehicle.

The air conditioning unit 1 according to the first embodiment is illustrated in FIG. 10, wherein FIGS. 10 to 16 illustrate the installation of a connection hub 50. As a first step of the installation, the second molded part 18A is removed. This exposes the first air circuit. In a wall part of the third molded part 27, a cover insert 61 is located and arranged to cover a cutout region 60. The cutout region 60 can be best seen in FIGS. 4, 5 and 8, in which the cover insert 61 is not shown. As shown in FIG. 11, the cover insert 61 is removed from the cutout region 60, here by lifting it in an upwards direction. The respective insertion and removal of the cover insert 61 into and from the cutout region 60 is assisted by guiding rails and grooves formed at the respective parts. The cover insert 61 is formed of an expanded polypropylene material as well.

As illustrated in FIG. 12, as a next step another cover insert 61 of different shape is reinserted into the cutout region 60. This particular cover insert 61 has through holes 62. The through holes 62 are intended for routing cables through the cover insert 61 from the exterior to the interior of the air conditioning unit 1. The through holes 62 are equipped with a rubber gasket to provide for a sealing. Thus, no air leaks out the first air circuit.

Adjacent to the cover insert 61, a cable guiding part 65 is placed inside the air duct of the first air circuit formed by the third molded part 27, after the cables (not shown) are installed. The cable guiding part 65 protects the cables from damage and prevents the cables from moving around caused by the air flow and vibrations. The cables (not shown) are routed to the outside via the air vents 22 at the side of the base part 26 of housing 2.

The connection hub 50 has four ports 52 configured and designed to receive the cables therethrough, as can be identified best in FIG. 13. Each port 52 is connected to a cable duct 51 that guides the cable from the port 52 to the air vents 22 in the housing 2. The cable ducts 51 have a distance to each other so that each cable duct 51 is directed towards a slot of the air vents 22. In the mounting step illustrated in FIG. 13, the connection hub is being attached and fixed to the housing via the connection means 53, which then turns out as shown in FIG. 14. The cables (not shown) are now guided, for example, from the inside of the vehicle, through the first opening 20, then guided by the cable guiding part 65 to the through holes 62 in the cover insert 61 and via the air vents 22, through the cable ducts 51, out from the ports 52 of the connection hub 50. The casing 16 is then closed again by placing the second molded part 18A on the first molded part 17A, as shown in FIG. 15. Finally, the air conditioning unit 1 is closed by the lid part 25 of the housing 2, as shown in FIG. 16.

In FIGS. 17 to 20, while referring again to the first embodiment of the air conditioning unit 1, the mounting of an antenna 80 into the air conditioning unit 1 is illustrated. The second molded part 18A formed of expanded polypropylene has an accommodation area 81 for the antenna 80. The accommodation area 81 is formed in the second molded part 18A on an upper portion of the second molded part 18A. In the accommodation area 81 the antenna 80 is placed, as shown in FIG. 18. The exterior shape of the antenna 80 is thereby adapted to the shape of the accommodation area 81, or vice versa. Thus, the antenna 80 fits into the accommodation area 81. Furthermore, the second molded part 18A has a groove 82 for guiding a cable or a plurality of cables (not shown) of the antenna 80 from the accommodation area 81 to the connection area between the second molded part 18A and the third molded part 27. The cable is guided to the inside of the first air circuit and further through the first opening 20 (not shown here).

The cable or cables (not shown), respectively, are further guided to the inside of the vehicle to an air distribution unit 100, as shown in FIG. 19. The air distribution unit 100 is mounted to the roof 110 inside the vehicle. By the air distribution unit 100 the cooled air can be distributed inside the vehicle via the lateral outlets 102. The lateral outlets are adjustable so that the air distribution can be adapted by the user to his or her needs. Inside the air distribution unit 100, which is hidden by the cover 101, the cable or cables of the antenna 80 can be connected to a signal emitter, for example a WiFi-router (not shown). The air distribution unit 100 covered by the cover 101 has a mounting area (not shown) for mounting the signal emitter. Furthermore, the signal emitter is connected to the power source of the vehicle for the air conditioning unit 1 for receiving electrical power.

FIG. 20 finally illustrates the readily assembled air conditioning system, including the air conditioning unit 1 closed again by the lid part 25 of the housing 2 and the air distribution unit 100 from a side and mounted to the roof 110 of a vehicle.

It is to be noted that in the afore-said reference has been made to the first embodiment of the air conditioning unit 1 when describing the features if the connection hub 50 and/or the antenna 80 wherein these features work with the second embodiment of the air conditioning unit 1 as well and in the same manner as described with the first embodiment.

### REFERENCE NUMERALS

1 Air conditioning unit
2 housing
3 evaporator
4 condenser
5 first fan arrangement
6 second fan arrangement
7A first fan of first fan arrangement
7B first fan of second fan arrangement
8A first impeller of first fan arrangement
8B first impeller of second fan arrangement
9A first shaft of first fan arrangement
9B first shaft of second fan arrangement
10A second fan of first fan arrangement
10B second fan of second fan arrangement
11A second impeller of first fan arrangement
11B second impeller of second fan arrangement
12A second shaft of first fan arrangement
12B second shaft of second fan arrangement
13 common motor
14 first motor
15 second motor
16 casing
17A first molded part for first fan arrangement
17B first molded part for second fan arrangement
18A second molded part for first fan arrangement
18B second molded part for second fan arrangement
19 base portion
20 first opening
21 second opening
22 first air vents
23 second air vents
24 connection area
25 lid part of housing
26 base part of housing
27 third molded part
30 condenser housing
31 front opening
40 control unit
50 connection hub
51 cable ducts
52 port
53 connection means
60 cutout region
61 cover insert
62 through holes
65 cable guiding part
80 antenna
81 accommodation area
82 groove
100 air distribution unit
101 cover
102 outlet of air distribution unit
110 roof

1. An air conditioning unit configured to be mounted externally on a vehicle and which comprising a housing that spatially separates an interior of the air conditioning unit from the environment,
wherein the air conditioning unit is configured such that a connection hub is removably mountable to the outside of the housing in order to route one or more cables from the environment to the interior of the air conditioning unit via the connection hub.

2. The air conditioning unit of claim 1, wherein the air conditioning unit is configured such that the cables can be further routed inside the vehicle.

3. The air conditioning unit of claim 1, wherein the air conditioning unit has a connection area for providing a sealed connection to the vehicle,
wherein, in the connection area, the housing has a first opening and a second opening,
wherein the air conditioning unit further comprises a first air circuit that extends inside the air conditioning unit between the first opening and the second opening,
wherein, during operation of the air conditioning unit, air from the interior of the vehicle is drawn through the first opening into the first air circuit and is fed through the second opening back into the interior of the vehicle, and
wherein the air conditioning unit is configured such that the cables can be routed along at least a part of the first air circuit and inside the vehicle via the first opening or the second opening.

4. The air conditioning unit of claim 3, wherein the air conditioning unit further comprises a casing forming an air duct serving as at least a portion of the first air circuit inside the casing, wherein the casing is configured to provide access for the cables inside the portion of the first air circuit formed by the casing.

5. The air conditioning unit of claim 4, wherein the casing has a cutout region for providing the access, wherein the cutout region is designed to removably receive a cover insert to cover the cutout region, which cover insert may have one or more through holes for routing the cables as intended.

6. The air conditioning unit of claim 4, wherein the casing is configured so that a cable guiding part for further guiding the cables inside the first air circuit is removably mountable to the casing at a region inside the air duct formed by the casing.

7. The air conditioning unit of claim 4, wherein the casing being composed of at least two molded parts connected to each other and the cutout region is located at a connection area between two the molded parts.

8. The air conditioning unit of claim 7, wherein the at least two molded parts are formed of a plastic foam material.

9. The air conditioning unit of claim 8, wherein the plastic foam material includes expanded polypropylene.

10. The air conditioning unit of claim 1, wherein the air conditioning unit includes the connection hub being removably mounted to the outside of the housing.

11. The air conditioning unit of claim 10, wherein the connection hub comprises a plurality of cable ducts for routing the cables from the environment through the connection hub and into the interior of the air conditioning unit.

12. The air conditioning unit of claim 5, wherein the air conditioning unit includes the cover insert being arranged in the cutout region of the casing, wherein the cover insert has one or more through holes for routing the cables as intended.

13. The air conditioning unit of claim 12, wherein the cover insert is formed of a plastic foam material.

14. The air conditioning unit of claim 12, wherein the cover insert comprises a rubber gasket at the one or more through holes.

15. The air conditioning unit of claim 6, wherein the air conditioning unit includes the cable guiding part being removably mounted to the casing at a region inside the air duct formed by the casing and in the vicinity of the cover insert.

16. The air conditioning unit of claim 15, wherein the cable guiding part is formed of a plastic foam material.

17. A construction kit comprising a connection hub for routing one or more cables, wherein the connection hub is configured to be removably mountable to the outside of the housing of an air conditioning unit, in order to route one or more cables from the environment to the interior of the air conditioning unit via the connection hub.
